(19) United States
(12) Patent Application Publication
(10) Pub. No.: US 2026/0364922 A1
(43) Pub. Date: Nov. 19, 2026

(54) GLASS FOR BUILDINGS, VEHICLES, OR SENSORS, CURVED GLASS, AIR-COOLED TEMPERED GLASS, AND LAMINATED GLASS

(71) Applicant: AGC Inc., Tokyo (JP)

(72) Inventors: Takato KAJIHARA, Tokyo (JP); Shigeki SAWAMURA, Tokyo (JP)

(73) Assignee: AGC Inc., Tokyo (JP)

(21) Appl. No.: 19/721,346

(22) Filed: Jun. 26, 2026

Related U.S. Application Data
(63) Continuation of application No. PCT/JP2024/045674, filed on Dec. 24, 2024.

(30) Foreign Application Priority Data
Dec. 27, 2023 (JP) 2023-221646

(51) Int. Cl. B32B 17/10; B32B 27/06; B32B 27/30; B32B 37/10; C03C 3/091

(52) U.S. Cl. CPC B32B 17/10036; B32B 17/10119; B32B 17/10137; B32B 17/10761; B32B 17/10816; B32B 17/10981; B32B 27/06; B32B 27/30; B32B 37/10; C03C 3/091; B32B 2307/72; B32B 2307/7376; B32B 2315/08; B32B 2329/06; B32B 2419/00; B32B 2457/00; B32B 2551/00; B32B 2605/08

(57) ABSTRACT

A glass for a building, for a vehicle, or for a sensor, containing, in terms of mol % based on oxides: SiO₂: 65% to 80%; B₂O₃: 8.0% to 20%; Al₂O₃: 1.0% to 6.0%; MgO: 0.0% to 5.0%; CaO: 0.0% to 5.0%; SrO: 0.0% to 5.0%; BaO: 0.0% to 5.0%; Li₂O: 0.0% to 10%; Na₂O: 5.0% to 20%; K₂O: 0.0% to 10%; total iron oxide in terms of Fe₂O₃: 0.004% to 1.0%; R′₂O: 5.0% to 20%; and RO: 0.0% to 5.0% where RO represents a total content of MgO, CaO, SrO, and BaO, and R′₂O represents a total content of Li₂O, Na₂O, and K₂O, and having a fictive temperature Tf being glass transition temperature+10 °C or higher and being 500 °C or higher and 750 °C or lower.

### CROSS-REFERENCE TO RELATED APPLICATIONS

This is a continuation of International Application No. PCT/JP2024/045674 filed on Dec. 24, 2024, and claims priority from Japanese Patent Application No. 2023-221646 filed on Dec. 27, 2023, the entire content of which is incorporated herein by reference.

### TECHNICAL FIELD

The present invention relates to a glass for a building, for a vehicle, or for a sensor, a bent glass, an air-cooled tempered glass, and a laminated glass.

### BACKGROUND ART

In recent years, a mobility-use glass such as a glass for a vehicle and a cover glass for a sensor such as a light detection and ranging (LiDAR) is required to have durability in order to extend the life cycle from the viewpoint of carbon neutrality. In order to improve the durability of the glass, for example, it is effective to increase a Young's modulus of the glass (see, for example, Patent Literatures 1 and 2).

On the other hand, the mobility-use glass is required to have formability since the glass is to be formed into a curved shape from the viewpoint of improving designability, operability, and visibility. The glass having a curved shape is produced by a method in which a flat glass plate is heated and bent using a mold (see Patent Literature 3).

### CITATION LIST

### Patent Literature

Patent Literature 1: WO2012/086664
Patent Literature 2: JP2019-529298A
Patent Literature 3: WO2014/167894

### SUMMARY OF INVENTION

### Technical Problem

However, a glass having a high Young's modulus is likely to have a high viscosity and density. Therefore, such a glass is not suitable for use in applications requiring bending. For example, the glass described in Patent Literature 1 has a high Young's modulus of 81 GPa or more, but has a high glass transition temperature of 600 °C or higher. In addition, the glass described in Patent Literature 2 has a high Young's modulus of 85 GPa or more, but has a high annealing point of 800 °C or higher. In this manner, it has been difficult to realize a glass exhibiting excellent durability and formability by the technique in the related art.

In view of the above problems, an object of the present invention is to provide a glass for a building, for a vehicle, or for a sensor, a bent glass, an air-cooled tempered glass, and a laminated glass, which have excellent durability and formability.

### Solution to Problem

The inventors of the present invention have found that the above problems can be solved by using a glass having a specific composition range, and have completed the present invention.

That is, the present invention is as follows.

1. A glass for a building, for a vehicle, or for a sensor,
containing, in terms of mol % based on oxides:
SiO₂: 65% to 80%;
B₂O₃: 8.0% to 20%;
Al₂O₃: 1.0% to 6.0%;
MgO: 0.0% to 5.0%;
CaO: 0.0% to 5.0%;
SrO: 0.0% to 5.0%;
BaO: 0.0% to 5.0%;
Li₂O: 0.0% to 10%;
Na₂O: 5.0% to 20%;
K₂O: 0.0% to 10%;
total iron oxide in terms of Fe₂O₃: 0.004% to 1.0%;
R′₂O: 5.0% to 20%; and
RO: 0.0% to 5.0% where RO represents a total content of MgO, CaO, SrO, and BaO, and R′₂O represents a total content of Li₂O, Na₂O, and K₂O, and having a fictive temperature Tf being a glass transition temperature+10 °C or higher and being 500 °C or higher and 750 °C or lower.

2. The glass according to the above 1, in which the fictive temperature Tf is lower than 650 °C.

3. The glass according to the above 1, in which the fictive temperature Tf is 650 °C or higher.

4. The glass according to any one of the above 1 to 3, which is a bent glass.

5. The glass according to any one of the above 1 to 3, which is an air-cooled tempered glass.

6. The glass according to the above 5, having a compressive stress (CS) of 30 MPa or more and a compressive stress layer depth (DOL) of 0.2×t (mm) or more, t representing a thickness (mm) of the air-cooled tempered glass.

7. A laminated glass including:
a first glass plate;
a second glass plate; and
an interlayer sandwiched between the first glass plate and the second glass plate, in which
the first glass plate, the second glass plate, or both is the glass according to any one of the above 1 to 6.

8. The laminated glass according to the above 7, in which a relationship between a thickness t1 of the first glass plate and a thickness t2 of the second glass plate is t1≥ t2.

9. The laminated glass according to the above 7 or 8, in which the thickness t1 of the first glass plate is 3.0 mm or more, the thickness t2 of the second glass plate is 1.1 mm or more, and a total t1+t2 of t1 and t2 is 10 mm or less.

### Advantageous Effects of Invention

According to the present invention, it is possible to provide a glass for a building, for a vehicle, or for a sensor, a bent glass, an air-cooled tempered glass, and a laminated glass, which have excellent durability and formability.

### BRIEF DESCRIPTION OF DRAWINGS

FIG. 1 is a cross-sectional view of an example of a laminated glass according to one embodiment of the present invention.

FIG. 2 is a conceptual view illustrating a state where the laminated glass according to one embodiment of the present invention is used as a vehicular window glass.

FIG. 3 is an enlarged view of portion S in FIG. 2.

FIG. 4 is a cross-sectional view taken along line Y-Y in FIG. 3.

### DESCRIPTION OF EMBODIMENTS

Hereinafter, embodiments of the present invention are described in detail.

In the following drawings, members and portions having the same functions may be denoted by the same reference numerals, and duplicate descriptions may be omitted or simplified. The embodiments described in the drawings are schematic for the purpose of clearly illustrating the present invention, and do not necessarily accurately represent a size or a scale of an actual product.

In the present description, a numerical range indicated by using “to” indicates a range including numerical values described before and after “to” as a minimum value and a maximum value, respectively.

Hereinafter, a glass according to the present embodiment is described as an embodiment of a glass for a building, for a vehicle, or for a sensor (hereinafter sometimes simply referred to as a “glass”) according to the present invention.

The glass according to the present embodiment is a glass for a building, for a vehicle, or for a sensor containing, in terms of mol % based on oxides:
SiO₂: 65% to 80%;
B₂O₃: 8.0% to 20%;
Al₂O₃: 1.0% to 6.0%;
MgO: 0.0% to 5.0%;
CaO: 0.0% to 5.0%;
SrO: 0.0% to 5.0%;
BaO: 0.0% to 5.0%;
Li₂O: 0.0% to 10%;
Na₂O: 5.0% to 20%;
K₂O: 0.0% to 10%;
total iron oxide in terms of Fe₂O₃: 0.004% to 1.0%;
R′₂O: 5.0% to 20%; and
RO: 0.0% to 5.0% where RO represents a total content of MgO, CaO, SrO, and BaO, and R′₂O represents a total content of Li₂O, Na₂O, and K₂O, and
having a fictive temperature Tf being a glass transition temperature+10 °C or higher and being 500 °C or higher and 750 °C or lower.

### [Glass Composition]

A composition range of each component will hereinafter be expressed in terms of mol % based on oxides unless otherwise specified. In addition, “not substantially contained” with respect to a component means that the component is not contained except for inevitable impurities mixed in from raw materials and the like, that is, the component is not intentionally contained.

SiO₂ is a component constituting a network structure of the glass, and is an essential component of the glass according to the present embodiment. In the glass according to the present embodiment, the content of SiO₂ is 65% to 80%. In the glass according to the present embodiment, when the content of SiO₂ is 65% or more, the glass structure is strengthened, and the Young's modulus can be increased. In addition, the density of the glass can be easily reduced, and moisture resistance and chemical durability can be ensured. Further, the viscosity of the glass can be decreased. In addition, the average linear expansion coefficient is prevented from increasing, and thermal cracking of the glass can be prevented. The content of SiO₂ is more preferably 68% or more, still more preferably 70% or more, even more preferably 72% or more, particularly preferably 74% or more, and most preferably 75% or more.

In addition, in the glass according to the present embodiment, when the content of SiO₂ is 80% or less, an increase in the viscosity during glass melting is prevented, production of the glass is facilitated, and formability for a vehicular glass, particularly a windshield, and a cover glass for sensors, is improved. The content of SiO₂ is preferably 79% or less, more preferably 78% or less, still more preferably 77% or less, and particularly preferably 76% or less.

B₂O₃ decreases the viscosity and the density of the glass and contributes to the improvement of the Young's modulus. It is also a component for controlling optical properties. In the glass according to the present embodiment, the content of B₂O₃ is 8.0% to 20%. When 8.0% or more of B₂O₃ is contained in the glass according to the present embodiment, the viscosity and the density of the glass can be decreased. In addition, the Young's modulus can be increased by controlling a coordination number to be described later. In the glass according to the present embodiment, the content of B₂O₃ is preferably 9.0% or more, more preferably 10% or more, still more preferably 11% or more, and particularly preferably 12% or more.

In addition, in the glass according to the present embodiment, when the content of B₂O₃ is 20% or less, an alkali element is less likely to volatilize during melting and forming of the glass, and a decrease in glass quality can be prevented. In addition, acid resistance and alkali resistance can be improved. The content of B₂O₃ is preferably 18% or less, more preferably 17% or less, still more preferably 16% or less, particularly preferably 15% or less, and most preferably 14% or less.

In the glass, boron can have an oxygen coordination number of three or four. The four-coordinated boron enters the glass framework and forms a tetrahedral structure. At this time, since the tetrahedral structure is negatively charged, the charge is compensated for by alkali metal ions or alkaline earth metal ions. Thus, the four-coordinated boron forms a three-dimensional glass structure with little generation of non-bridging oxygen. On the other hand, it is known that the three-coordinated boron has non-bridging oxygen in the glass and forms a planar structure such as a ring structure (boroxol ring).

The Young's modulus tends to decrease as the content of the three-coordinated boron increases, and the Young's modulus tends to increase as the content of the four-coordinated boron increases. As the Young's modulus decreases, formability of the glass is improved. The reason why the Young's modulus decreases as the content of the three-coordinated boron increases is thought to be that when the ratio of the four-coordinated boron decreases and the ratio of the three-coordinated boron increases, the amount of non-bridging oxygen increases, so that the ion packing rate and the bond dissociation energy that contribute to the Young's modulus decrease.

In the glass according to the present embodiment, the content of the three-coordinated boron in terms of B₂O₃ (B₃ as B₂O₃) is preferably 10% or less, more preferably 9.5% or less, still more preferably 9.0% or less, even more preferably 8.5% or less, even still more preferably 8.0% or less, yet still more preferably 7.5% or less, particularly preferably 7.0% or less, and most preferably 6.5% or less.

In addition, the content of three-coordinated boron is preferably 1.5% or more, more preferably 2.0% or more, still more preferably 2.5% or more, even more preferably 3.0% or more, particularly preferably 3.5% or more, and most preferably 4.0% or more, from the viewpoint of preventing an increase in the viscosity due to an increase in glass network formation by the four-coordinated boron.

Note that the ratios of the three-coordinated boron and the four-coordinated boron in the glass can be measured by nuclear magnetic resonance (NMR).

Al₂O₃ is a component constituting the network structure of the glass, and is an essential component of the glass according to the present embodiment. In the glass according to the present embodiment, the content of Al₂O₃ is 1.0% to 6.0%.

In the glass according to the present embodiment, when the content of Al₂O₃ is 1.0% or more, the Young's modulus can be increased. In addition, weather resistance, moisture resistance, and chemical durability are improved. In addition, the average linear expansion coefficient is not excessively increased, the thermal cracking of the glass can be prevented, and a chemical strengthening treatment using ion exchange is possible. The content of Al₂O₃ is preferably 1.5% or more, more preferably 1.8% or more, still more preferably 2.0% or more, particularly preferably 2.3% or more, and most preferably 2.5% or more.

In addition, in the glass according to the present embodiment, when the content of Al₂O₃ is 6.0% or less, an increase in the viscosity during glass melting is prevented, production of the glass is facilitated, and formability for a vehicular glass, particularly a windshield, and a cover glass for sensors, is improved. In addition, it is preferable to keep the content of Al₂O₃ low, as the ratio of the four-coordinated boron can be increased. The content of Al₂O₃ is preferably 5.0% or less, more preferably 4.5% or less, still more preferably 4.0% or less, particularly preferably 3.5% or less, and most preferably 3.0% or less.

MgO is a component that decreases the viscosity of the glass and that contributes to the improvement of the Young's modulus. In addition, it is a component that increases the ratio of the three-coordinated boron among the alkaline earth metals because of its high electronegativity. In the glass according to the present embodiment, the content of MgO is 0.0% to 5.0%.

When MgO is contained in the glass according to the present embodiment, the viscosity of the glass can be decreased, and the melting of glass raw materials can be promoted. In addition, the Young's modulus and moisture resistance can be improved. In the case where the glass according to the present embodiment contains MgO, the content thereof is preferably 0.20% or more, more preferably 0.40% or more, still more preferably 0.60% or more, particularly preferably 0.80% or more, and most preferably 1.0% or more.

In addition, in the glass according to the present embodiment, when the content of MgO is 5.0% or less, the glass is less likely to undergo devitrification, the viscosity of the glass is prevented from excessively increasing during glass melting, production of the glass is facilitated, and formability for a vehicular glass, particularly a windshield, and a cover glass for sensors, is improved. The content of MgO is preferably 4.0% or less, more preferably 3.0% or less, still more preferably 2.5% or less, particularly preferably 2.0% or less, and most preferably 1.5% or less.

CaO is a component that decreases the viscosity of the glass. In addition, it is a component that increases the ratio of the three-coordinated boron, following MgO among the alkaline earth metals because of its high electronegativity. In the glass according to the present embodiment, the content of CaO is 0.0% to 5.0%.

When CaO is contained in the glass according to the present embodiment, meltability of the glass raw materials is improved, and the viscosity is further decreased, so that formability is improved. In the case where the glass according to the present embodiment contains CaO, the content thereof is preferably 0.20% or more, more preferably 0.40% or more, still more preferably 0.60% or more, particularly preferably 0.80% or more, and most preferably 1.0% or more.

In addition, in the glass according to the present embodiment, when the content of CaO is 5.0% or less, an increase in the density of the glass can be prevented, the average linear expansion coefficient can be reduced, and the thermal cracking of the glass can be prevented.

Further, the ratio of the three-coordinated boron can be kept low. In the glass according to the present embodiment, the content of CaO is preferably 4.0% or less, more preferably 3.5% or less, still more preferably 3.0% or less, particularly preferably 2.5% or less, and most preferably 2.0% or less.

SrO is a component that decreases the viscosity of the glass. In the glass according to the present embodiment, the content of SrO is 0.0% to 5.0%.

In the glass according to the present embodiment, when the content of SrO is 5.0% or less, an increase in the density of the glass can be prevented. In the glass according to the present embodiment, the content of SrO is preferably 4.0% or less, more preferably 3.0% or less, still more preferably 2.0% or less, even more preferably 1.0% or less, and particularly preferably 0.50% or less, and it is most preferable that SrO is not substantially contained. In the glass according to the present embodiment, SrO not being substantially contained means that the content of SrO in the glass is 0.10 mol % or less.

In the case where SrO is contained in the glass according to the present embodiment, the content of SrO may be 0.20% or more, 0.40% or more, 0.60% or more, 0.80% or more, or 1.0% or more.

BaO is a component that decreases the viscosity of the glass. In the glass according to the present embodiment, the content of BaO is 0.0% to 5.0%.

In the glass according to the present embodiment, when the content of BaO is 5.0% or less, an increase in the density of the glass can be prevented. In the glass according to the present embodiment, the content of BaO is preferably 4.0% or less, more preferably 3.0% or less, still more preferably 2.0% or less, even more preferably 1.0% or less, and particularly preferably 0.50% or less, and it is most preferable that BaO is not substantially contained. In the glass according to the present embodiment, BaO not being substantially contained means that the content of BaO in the glass is 0.10 mol % or less.

In the case where BaO is contained in the glass according to the present embodiment, the content of BaO may be 0.20% or more, 0.40% or more, 0.60% or more, 0.80% or more, or 1.0% or more.

In the glass according to the present embodiment, the total content of MgO, CaO, SrO, and BaO (hereinafter sometimes referred to as RO) is 0.0% to 5.0%. When at least one selected from MgO, CaO, SrO, and BaO is contained, the Young's modulus can be increased. In the case where at least one selected from MgO, CaO, SrO, and BaO is contained, the RO is preferably 0.20% or more, more preferably 0.40% or more, still more preferably 0.60% or more, particularly preferably 0.80% or more, and most preferably 1.0% or more.

In addition, when the RO is 5.0% or less, an increase in the density of the glass can be prevented, and crack resistance of the glass can be improved. The RO is preferably 4.5% or less, more preferably 4.0% or less, still more preferably 3.5% or less, even more preferably 3.0% or less, particularly preferably 2.5% or less, and most preferably 2.0% or less.

Li₂O is a component that improves meltability of the glass and that decreases the viscosity. In addition, it is a component that increases the Young's modulus and that contributes to the average linear expansion coefficient of the glass. Further, strength of the glass can be increased by performing a chemical strengthening treatment by ion exchange with Na ions. In the glass according to the present embodiment, the content of Li₂O is 0.0% to 10%.

When Li₂O is contained in the glass according to the present embodiment, the viscosity of the glass can be decreased as compared with Na₂O or K₂O. The content of Li₂O is preferably 0.50% or more, more preferably 1.0% or more, still more preferably 1.5% or more, even more preferably 2.0% or more, particularly preferably 2.5% or more, and most preferably 3.0% or more.

In addition, in the glass according to the present embodiment, when the content of Li₂O is 10% or less, the thermal cracking of the glass due to an excessively large average linear expansion coefficient can be prevented. In addition, generation of a crystal phase containing Li during the production of the glass is prevented, and productivity of the glass is improved. The content of Li₂O is preferably 9.0% or less, more preferably 8.0% or less, still more preferably 7.0% or less, particularly preferably 6.0% or less, and most preferably 5.0% or less.

Na₂O is a component that improves meltability of the glass and that decreases the viscosity of the glass, and is a component that makes it easier to increase the Young's modulus and that also contributes to the average linear expansion coefficient of the glass. Further, the strength of the glass can be increased by performing a chemical strengthening treatment by ion exchange with K ions. In the glass according to the present embodiment, the content of Na₂O is 5.0% to 20%.

When Na₂O is contained in the glass according to the present embodiment, the viscosity of the glass can be decreased. In addition, the Young's modulus and the average linear expansion coefficient can be increased. The content of Na₂O is preferably 5.5% or more, more preferably 6.0% or more, still more preferably 6.5% or more, even more preferably 6.8% or more, even still more preferably 7.0% or more, particularly preferably 7.2% or more, and most preferably 7.5% or more.

In addition, when the content of Na₂O is 20% or less, the thermal cracking of the glass due to an excessively large average linear expansion coefficient can be prevented. In addition, since moisture resistance of the glass is improved, the glass is suitable for use as a glass to be exposed to the atmosphere for a long period of time, such as a vehicular window glass. The content of Na₂O is preferably 18% or less, more preferably 15% or less, still more preferably 13% or less, even more preferably 12% or less, particularly preferably 11% or less, and most preferably 10% or less.

K₂O is a component that improves meltability of the glass and that decreases the viscosity of the glass, and is a component that makes it easier to increase the Young's modulus and that also contributes to the average linear expansion coefficient of the glass. In the glass according to the present embodiment, the content of K₂O is 0.0% to 10%.

When K₂O is contained in the glass according to the present embodiment, the viscosity of the glass can be decreased. In addition, the Young's modulus and the average linear expansion coefficient can be increased. In the case where K₂O is contained, the content thereof is preferably 0.30% or more, more preferably 0.50% or more, still more preferably 0.70% or more, particularly preferably 0.90% or more, and most preferably 1.0% or more.

On the other hand, K₂O has an effect of increasing the average linear expansion coefficient and the density as compared with Li₂O and Na₂O. When the content of K₂O is 10% or less, the thermal cracking of the glass due to an excessively large average linear expansion coefficient can be prevented. The content of K₂O is preferably 8.0% or less, more preferably 6.0% or less, still more preferably 5.0% or less, even more preferably 4.0% or less, particularly preferably 3.0% or less, and most preferably 2.0% or less.

In the glass according to the present embodiment, the total content of Li₂O, Na₂O, and K₂O (hereinafter sometimes referred to as R′₂O) is 5.0% to 20%. When the R′₂O is 5.0% or more, the Young's modulus increases and the viscosity of the glass decreases, so that formability is improved. The content of R′₂O is preferably 5.5% or more, more preferably 6.0% or more, still more preferably 6.5% or more, even more preferably 7.0% or more, particularly preferably 7.5% or more, and most preferably 8.0% or more.

In addition, when the R′₂O is 20% or less, an increase in the density can be prevented, and moisture resistance of the glass can be further improved. The R′₂O is preferably 19% or less, more preferably 17% or less, still more preferably 15% or less, particularly preferably 14% or less, 13% or less, and 12% or less in this order, and most preferably 11% or less.

Fe₂O₃ is a component that improves the heat shielding property of the glass and is a component that also contributes to the color tone of the glass. In the glass according to the present embodiment, the content of the total iron oxide in terms of Fe₂O₃ is 0.004% to 1.0%. Note that the content of the total iron oxide in terms of Fe₂O₃ here refers to the total amount of iron oxides including FeO, which is an oxide of divalent iron, and Fe₂O₃, which is an oxide of trivalent iron.

In the glass according to the present embodiment, when the content of the total iron oxide in terms of Fe₂O₃ is 0.004% or more, the heat shielding property can be improved, designability can be imparted, heat can be more readily transferred to the glass during glass bending, and formability can be improved. In addition, in the glass according to the present embodiment, when the content of the total iron oxide in terms of Fe₂O₃ is 1.0% or less, a decrease in light transmittance in the visible region can be prevented.

In the case where the glass according to the present embodiment is used as a building glass, the content of the total iron oxide in terms of Fe₂O₃ is preferably 0.008% or more, more preferably 0.016% or more, still more preferably 0.020% or more, even more preferably 0.023% or more, even still more preferably 0.031% or more, particularly preferably 0.035% or more, and most preferably 0.040% or more, from the viewpoint of improving the heat shielding property and imparting designability.

In addition, in the case where the glass according to the present embodiment is used as a building glass, the content of the total iron oxide in terms of Fe₂O₃ is preferably 0.80% or less, more preferably 0.60% or less, still more preferably 0.40% or less, particularly preferably 0.20% or less, and most preferably 0.10% or less, from the viewpoint of further preventing a decrease in light transmittance in the visible region.

In the case where the glass according to the present embodiment is used as a vehicular glass, the content of the total iron oxide in terms of Fe₂O₃ is preferably 0.020% or more, more preferably 0.040% or more, still more preferably 0.10% or more, even more preferably 0.12% or more, particularly preferably 0.13% or more, and most preferably 0.14% or more, from the viewpoint of improving the heat shielding property, imparting designability, and facilitating heat transfer to the glass during glass bending.

In addition, in the case where the glass according to the present embodiment is used as a vehicular glass, the content of the total iron oxide in terms of Fe₂O₃ is preferably 0.80% or less, more preferably 0.60% or less, still more preferably 0.40% or less, particularly preferably 0.30% or less, and most preferably 0.25% or less, from the viewpoint of further preventing a decrease in light transmittance in the visible region.

In the case where the glass according to the present embodiment is used as a sensor glass (for example, a cover glass of a LiDAR or a camera), the content of the total iron oxide in terms of Fe₂O₃ is more preferably 0.0040% or more, and still more preferably 0.0042% or more, from the viewpoint of further facilitating melting of raw materials during the production of the glass and from the viewpoint of further reducing the amount of expensive high-purity raw materials used.

In addition, the content of the total iron oxide in terms of Fe₂O₃ is more preferably 0.020% or less, still more preferably 0.010% or less, even more preferably 0.0080% or less, particularly preferably 0.0070% or less, and most preferably 0.0060% or less, from the viewpoint of further preventing a decrease in light transmittance in the visible region or near-infrared region.

In the glass according to the present embodiment, the mass proportion (%) of divalent iron in terms of Fe₂O₃ in the total iron oxide in terms of Fe₂O₃ (hereinafter referred to as Fe-Redox) is preferably 15% or more. The Fe-Redox value is the ratio of the content of Fe²⁺ in terms of Fe₂O₃ to the content of the total iron oxide in terms of Fe₂O₃. When the Fe-Redox is 15% or more, the content of Fe²⁺ having an absorption in the near-infrared region can be increased, and thus heat can be more readily transferred to the molten glass during the production of the glass, and productivity is improved. In addition, since the transmittance in the near-infrared region decreases and the heat shielding property can be improved, the glass is suitable for use in applications requiring the heat shielding property, such as a building glass or a vehicular glass.

In the case where the glass according to the present embodiment is used as a building glass or a vehicular glass, the Fe-Redox is more preferably 20% or more, still more preferably 22% or more, and particularly preferably 24% or more, and is preferably 50% or less. In the case where the Fe-Redox is 50% or less, deterioration of a melting facility can be prevented, and in addition, in the case where SO₃ is used as a fining agent, amber coloring can be prevented and a decrease in visible light transmittance can be prevented. The Fe-Redox is more preferably 45% or less, still more preferably 40% or less, and particularly preferably 38% or less.

In the case where the glass according to the present embodiment is used as a sensor glass, the Fe-Redox is more preferably 16% or more, still more preferably 17% or more, and particularly preferably 18% or more, and is preferably 35% or less. When the Fe-Redox is 35% or less, a decrease in transmittance in the near-infrared region can be prevented. The Fe-Redox is more preferably 30% or less, still more preferably 28% or less, and particularly preferably 25% or less.

The Fe-Redox can be adjusted based on a raw material composition, melting temperature, and melting atmosphere. In addition, the Fe-Redox can be adjusted by controlling the oxidation-reduction degree of the molten glass by using a reducing agent, such as coke or ammonium chloride, as a raw material.

### [Other Components]

The glass according to the present embodiment may contain components other than the above components (hereinafter, also referred to as “other components”). Examples of the other components include TiO₂, ZrO₂, Y₂O₃, CeO₂, Nd₂O₅, GaO₂, GeO₂, MnO₂, NiO, Cr₂O₃, V₂O₅, Au₂O₃, Ag₂O, CuO, CdO, MoO₃, SO₃, Cl, F, SnO₂, and Sb₂O₃, and the other components may be metal ions or oxides.

The other components may be contained in an amount of preferably, for example, 3.0% or less in total for various purposes (for example, fining, coloring, or imparting chemical durability). When the total content of the other components is 3.0% or less, the glass can maintain properties necessary for a building glass, a vehicular glass, or a sensor glass. The total content of the other components is more preferably 2.5% or less, still more preferably 2.0% or less, even more preferably 1.5% or less, especially preferably 1.0% or less, particularly preferably 0.80% or less, and most preferably 0.50% or less. In order to prevent adverse influences on the environment, the contents of As₂O₃ and PbO are each preferably less than 0.0010%, and it is more preferable that As₂O₃ and PbO are not substantially contained.

The glass according to the present embodiment may contain ZrO₂. ZrO₂ is a component that improves chemical durability. In the case where the glass according to the present embodiment contains ZrO₂, the content thereof is preferably 0.010% or more, more preferably 0.050% or more, still more preferably 0.10% or more, and particularly preferably 0.20% or more. In addition, the content of ZrO₂ is preferably 2.0% or less, more preferably 1.5% or less, still more preferably 1.0% or less, and particularly preferably 0.50% or less, from the viewpoint of preventing an increase in the density and viscosity of the glass.

The glass according to the present embodiment may contain Y₂O₃. Y₂O₃ is a component that increases the Young's modulus. In the case where the glass according to the present embodiment contains Y₂O₃, the content thereof is preferably 0.10% or more, more preferably 0.20% or more, still more preferably 0.30% or more, and particularly preferably 0.40% or more. In addition, the content of Y₂O₃ is preferably 2.0% or less, more preferably 1.5% or less, still more preferably 1.0% or less, and particularly preferably 0.80% or less, from the viewpoint of preventing an increase in the density and viscosity of the glass.

In the case where the glass according to the present embodiment contains NIO, NiS may be formed to cause glass breakage, and thus the content of NiO is preferably 0.0080% or less. The content of NiO in the glass according to the present embodiment is more preferably 0.0040% or less, and still more preferably 0.0020% or less, and it is particularly preferable that NiO is not substantially contained.

The glass according to the present embodiment may contain CeO₂. CeO₂ has an absorption in the ultraviolet region, and thus reduces ultraviolet transmittance Tuv and improves UV cut performance. In addition, CeO₂ can act as an oxidizing agent to control the Fe-Redox. In the case where the glass according to the present embodiment contains CeO₂, the content thereof is preferably 0.010% or more, more preferably 0.020% or more, still more preferably 0.040% or more, and particularly preferably 0.070% or more. CeO₂ absorbs light in the ultraviolet region to cause solarization, and the transmittance in the visible region may decrease. Therefore, the content of CeO₂ is preferably 0.25% or less, more preferably 0.18% or less, still more preferably 0.14% or less, and particularly preferably 0.10% or less.

The glass according to the present embodiment may contain Cr₂O₃. Cr₂O₃ can act as an oxidizing agent to control the Fe-Redox. In the case where the glass according to the present embodiment contains Cr₂O₃, the content thereof is preferably 0.0020% or more, and more preferably 0.0040% or more. Since Cr₂O₃ causes coloration under light in the visible region, the visible light transmittance may decrease. In addition, the amount of Fe²⁺ may be reduced, and the heat shielding property may decrease. Therefore, in the case where the glass according to the present embodiment contains Cr₂O₃, the content thereof is preferably 0.020% or less, more preferably 0.016% or less, still more preferably 0.012% or less, and particularly preferably 0.0080% or less.

The glass according to the present embodiment may contain SnO₂. SnO₂ can act as a reducing agent to control the Fe-Redox. In the case where the glass according to the present embodiment contains SnO₂, the content thereof is preferably 0.010% or more, more preferably 0.040% or more, still more preferably 0.060% or more, and particularly preferably 0.080% or more. On the other hand, in order to prevent defects derived from SnO₂ during the production of the glass, the content of SnO₂ in the glass according to the present embodiment is preferably 0.40% or less, more preferably 0.30% or less, still more preferably 0.20% or less, and particularly preferably 0.15% or less.

The glass according to the present embodiment may contain SO₃. SO₃ acts as a fining agent and therefore improves bubble quality of the glass. In the case where the glass according to the present embodiment contains SO₃, the content thereof is preferably 0.0010% or more, more preferably 0.0040% or more, still more preferably 0.0070% or more, and particularly preferably 0.015% or more. In the case where the glass has a large Fe-Redox, SO₃ may promote amber coloring, resulting in browning of the glass and a decrease in visible light transmittance.

In the case where the glass according to the present embodiment contains SO₃, the content thereof is preferably 0.070% or less, more preferably 0.060% or less, still more preferably 0.050% or less, and particularly preferably 0.040% or less.

The glass according to the present embodiment may contain Cl. Cl acts as a fining agent and therefore improves bubble quality of the glass. In the case where the glass according to the present embodiment contains Cl, the content thereof is preferably 0.080% or more, more preferably 0.15% or more, still more preferably 0.20% or more, particularly preferably 0.25% or more, and most preferably 0.30% or more. When the content of Cl is large, Cl₂ gas volatilized from the molten glass may corrode surrounding members. In the case where glass according to the present embodiment contains Cl, the content thereof is preferably 1.0% or less, more preferably 0.80% or less, still more preferably 0.60% or less, and particularly preferably 0.50% or less.

### Properties

### (Fictive Temperature Tf)

The glass according to the present embodiment has a fictive temperature Tf being the glass transition temperature+10 °C or higher and being 500 °C or higher and 750 °C or lower. When the fictive temperature is too high, the ratio of the three-coordinated boron increases, the Young's modulus and the fracture toughness value are reduced, and durability decreases. On the other hand, when the fictive temperature is too low, the four-coordinated boron increases too much, the viscosity of the glass increases, and formability decreases. When the fictive temperature Tf is the glass transition temperature+10 °C or higher and is 500 °C or higher and 750 °C or lower, the glass according to the present embodiment exhibits excellent durability and formability.

The fictive temperature Tf of the glass according to the present embodiment is preferably the glass transition temperature+20 °C or higher, more preferably the glass transition temperature+30 °C or higher, still more preferably the glass transition temperature+50 °C or higher, particularly preferably the glass transition temperature+75 °C or higher, and most preferably the glass transition temperature+100 °C or higher.

As one aspect of the glass according to the present embodiment, the fictive temperature Tf is preferably 740 °C or lower, more preferably 725 °C or lower, still more preferably 700 °C or lower, and particularly preferably 675 °C or lower. When the fictive temperature Tf is 750 °C or lower, the ratio of the four-coordinated boron increases, and the Young's modulus and the fracture toughness value are increased, so that durability can be further improved. In such an aspect, the fictive temperature Tf is preferably 550 °C or higher, more preferably 575 °C or higher, still more preferably 600 °C or higher, and particularly preferably 625 °C or higher, from the viewpoint of increasing the ratio of the three-coordinated boron, decreasing the Young's modulus and the viscosity of the glass, and further improving formability. Specific examples of the glass according to such an aspect include a glass that has been subjected to bending and a glass that has been subjected to air-cooling tempering.

As described above, the coordination number of boron can be adjusted based on the fictive temperature Tf, and from this viewpoint, examples of one aspect of the glass according to the present embodiment include an aspect in which the fictive temperature Tf is lower than 650 °C or an aspect in which the fictive temperature Tf is 650 °C or higher.

The glass has a low viscosity and is in a liquid state at a high temperature, and at this time, the glass structure is in a coarse state, and as the glass is cooled, the glass structure is solidified while being dense. The structural change of the glass occurs when the glass attempts to transition to the most stable state at this temperature. However, when the cooling rate of the glass is high, the glass structure is solidified before being a stable structure, and the glass structure is fixed in a high temperature state. The temperature corresponding to the structure of the solidified glass is referred to as the fictive temperature Tf. That is, the fictive temperature Tf varies depending on the heat treatment in the production process even when the glass has exactly the same composition. In this manner, the glass structure varies depending on the heat treatment, and the physical properties thereof also vary.

The fictive temperature can be measured by a known method. An example of a method of measuring the fictive temperature Tf is described below. In the measurement of the fictive temperature, a calibration curve indicating the relationship between the fictive temperature and the refractive index n_{d} at the d line (587.6 nm) is created using reference glass substrates, the refractive index n_{d} of the glass substrate to be measured is measured, and the fictive temperature Tf can be calculated using the calibration curve.

First, a plurality of glass pieces having the same glass composition and different fictive temperatures are prepared by a method of holding the glass at a constant temperature and rapidly cooling the glass from the temperature. Since the fictive temperature of these glass pieces is the temperature at which they were held before the rapid cooling, a calibration curve in which the refractive index is plotted with respect to the fictive temperature is created by measuring the refractive index of these glass pieces. Next, the refractive index n_{d} of the glass substrate to be measured is measured, and the fictive temperature Tf can be calculated using the calibration curve. The refractive index can be measured by a precision refractometer (Kalnew Precision Refractometer KPR-2000 manufactured by Shimadzu Corporation) or the like.

More specifically, the fictive temperature Tf is determined by the following procedures 1) to 3).

1) First, i (i≥2) test pieces are prepared from a glass sample whose fictive temperature is to be measured, held at different cooling start temperatures until the refractive index reaches an equilibrium state, and then cooled at a cooling rate of 1,000 °C/min or more. Here, when the cooling start temperature is lower than the glass transition temperature, a sufficiently long holding time is required, and thus the cooling start temperature is preferably set to a temperature higher than the glass transition temperature by 10 °C to 200 °C. 2) The refractive index n_{d} of the glass cooled under the conditions described in the 1) is measured at a specific wavelength (for example, the d-line of a He lamp, 587.6 nm). For each cooling start temperature Tᵢ, a refractive index n_{di} of the glass rapidly cooled from the cooling start temperature is plotted to create a calibration curve. 3) Next, a test piece is cut out from the glass sample whose fictive temperature Tf is to be measured, and is polished, the refractive index n_{d} of the polished test piece is measured, and the fictive temperature Tf of the glass is determined using the calibration curve.

### (Average Linear Expansion Coefficient)

The glass according to the present embodiment has an average linear expansion coefficient (CTE) at 50 °C to 350 °C of preferably 40×10⁻⁷/°C or more, more preferably 45×10⁻⁷/°C or more, still more preferably 48×10⁻⁷/°C or more, particularly preferably 50×10⁻⁷/°C or more, particularly preferably 52×10⁻⁷/° °C or more, particularly preferably 54×10⁻⁷/°C or more, and most preferably 55×10⁻⁷/°C or more. When the average linear expansion coefficient is 40×10⁻⁷/° °C or more, formability and air-cooling tempering performance can be further improved.

In addition, the average linear expansion coefficient (CTE) at 50 °C to 350 °C of the glass according to the present embodiment is preferably 70×10⁻⁷/° °C or less, more preferably 68×10⁻⁷/°C or less, still more preferably 65×10⁻⁷/°C or less, even more preferably 62×10⁻⁷/°C or less, particularly preferably 61×10⁻⁷/°C or less, and most preferably 60×10⁻⁷/°C or less. When the average linear expansion coefficient is 70×10⁻⁷/°C or less, cracking due to heat shock can be prevented. In addition, when the glass according to the present embodiment is a bent glass, a difference in thermal expansion due to a difference in in-plane thermal history can be prevented, and a bent glass having a good dimension and surface accuracy can be obtained.

Examples of the methods for setting the average linear expansion coefficient within the above range include a method of adjusting the content of SiO₂ which is a component of the glass, a method of adjusting the contents of R′₂O and RO or Al₂O₃, the content of B₂O₃ or the coordination number of boron, and a method of adjusting the fictive temperature Tf.

### (Density)

The glass according to the present embodiment has a density of preferably 2.50 g/cm³ or less, more preferably 2.45 g/cm³ or less, still more preferably 2.40 g/cm³ or less, even more preferably 2.38 g/cm³ or less, even still more preferably 2.37 g/cm³ or less, particularly preferably 2.36 g/cm³ or less, and most preferably 2.35 g/cm³ or less. When the density is 2.50 g/cm³ or less, formability can be further improved, and a decrease in fuel efficiency and electric power efficiency due to an increase in the weight can be further prevented.

In addition, the density of the glass according to the present embodiment is preferably 2.23 g/cm³ or more, more preferably 2.25 g/cm³ or more, particularly preferably 2.27 g/cm³ or more, and most preferably 2.30 g/cm³ or more, from the viewpoint of improving sound insulation property.

In general, a glass having a low Young's modulus is likely to have a low density, but the glass according to the present embodiment can achieve a low Young's modulus while ensuring a sufficient density by adjusting the composition or the contents of R′₂O or RO which are components of the glass, the content of B₂O₃ or the coordination number of boron, and the fictive temperature Tf.

### (Young's Modulus)

The glass according to the present embodiment has a Young's modulus of preferably 80 GPa or less, more preferably 78 GPa or less, still more preferably 76 GPa or less, particularly preferably 74 GPa or less, and most preferably 72 GPa or less, from the viewpoint of improving formability of the glass and preventing cracking due to deformation of the glass when receiving an external force.

In addition, the Young's modulus of the glass according to the present embodiment is preferably 55 GPa or more, more preferably 60 GPa or more, still more preferably 62 GPa or more, even more preferably 64 GPa or more, particularly preferably 66 GPa or more, and most preferably 68 GPa or more, from the viewpoint of improving rigidity of the glass.

Examples of the method for setting the Young's modulus within the above range include a method of increasing the ratio of the three-coordinated boron, a method of adjusting the fictive temperature Tf, and a method of adjusting the kinds and the amounts of RO and R′₂O.

The Young's modulus can be measured by using an ultrasonic pulse method based on JIS R1602:1995 “Testing methods for elastic modulus of fine ceramics”.

### (Rigidity Modulus)

The glass according to the present embodiment has a rigidity modulus of preferably 24 GPa or more, more preferably 25 GPa or more, still more preferably 26 GPa or more, particularly preferably 27 GPa or more, and most preferably 28 GPa or more. When the rigidity modulus is 24 GPa or more, the glass is less likely to be deformed when receiving an external force.

In addition, the rigidity modulus of the glass according to the present embodiment is preferably 35 GPa or less, more preferably 34 GPa or less, still more preferably 33 GPa or less, and particularly preferably 32 GPa or less, since cracking can be prevented by deforming the glass to consume the energy when the glass receives an external force.

The rigidity modulus can be measured by using an ultrasonic pulse method based on JIS R1602:1995 “Testing methods for elastic modulus of fine ceramics”.

### (Poisson's Ratio)

The glass according to the present embodiment has a Poisson's ratio of preferably 0.25 or less, more preferably 0.24 or less, still more preferably 0.23 or less, particularly preferably 0.22 or less, particularly preferably 0.21 or less, particularly preferably 0.20 or less, and most preferably 0.19 or less. The smaller the Poisson's ratio, the smaller the stress generated when the glass receives an external force.

The Poisson's ratio can be measured by using an ultrasonic pulse method based on JIS R1602:1995 “Testing methods for elastic modulus of fine ceramics”.

### (Tg)

The glass according to the present embodiment has a glass transition temperature (Tg) in a range of preferably 460 °C to 590 °C. When the Tg is within this predetermined temperature range, the glass can be bent within general production condition ranges. When the Tg of the glass according to the present embodiment is 460 °C or higher, the contents of the alkali metals or the contents of the alkaline earth metals are not too large, and an increase in the average linear expansion coefficient of the glass can be prevented. In addition, moisture resistance and devitrification of the glass can be prevented, and formability can be improved. The Tg is more preferably 480 °C or higher, still more preferably 490 °C or higher, and particularly preferably 500 °C or higher.

In addition, the Tg is preferably 590 °C or lower, more preferably 585 °C or lower, still more preferably 580 °C or lower, particularly preferably 575 °C or lower, and most preferably 570 °C or lower, from the viewpoint of preventing the glass bending temperature from being excessively high and of facilitating production.

### (T₁₁)

In the glass according to the present embodiment, the temperature T₁₁, at which the glass viscosity η reaches 1011 [dPa·s] and which serves as a standard of bendability, is preferably 650 °C or lower, more preferably 645 °C or lower, still more preferably 640 °C or lower, even more preferably 635 °C or lower, particularly preferably 630 °C or lower, and most preferably 625 °C or lower. When the Tu is 650 °C or lower, it is possible to perform bending at a low temperature.

Examples of the method of setting the Tu to 650 °C or lower include a method of increasing the contents of R′₂O and RO which are components of the glass and reducing the content of Al₂O₃, a method of incorporating Li₂O among the R′₂O, a method of reducing the content of SiO₂, and a method of adjusting the content of B₂O₃ and the coordination number of boron.

In addition, the Ti is preferably 580 °C or higher, more preferably 585 °C or higher, still more preferably 590 °C or higher, particularly preferably 595 °C or higher, and most preferably 600 °C or higher, from the viewpoint of maintaining fracture toughness of the glass, from the viewpoint of preventing the average linear expansion coefficient of the glass from being too large, and from the viewpoint of the firing temperature of a black ceramic to be printed on a windshield.

In the case where the glass according to the present invention is used as a vehicular glass, the shape of the glass according to the present invention is not particularly limited, and the area of the main surface is preferably 0.25 m² or more, more preferably 0.45 m² or more, and still more preferably 0.90 m² or more. When the area of the glass is within the above range, the glass can be suitable for use in various vehicle types. In addition, when the area of the glass is too large, difficulty of bending increases, such as difficulty in handling, non-uniformity of temperature distribution during heating, and deterioration of dimensional accuracy after bending. Therefore, the area of the main surface of the glass according to the present invention is preferably 10 m² or less, more preferably 7 m² or less, and still more preferably 5 m² or less.

In the case where the glass according to the present invention is used as a sensor glass, the shape of the glass according to the present invention is not particularly limited, and the area of the main surface is preferably 0.00010 m² or more, more preferably 0.010 m² or more, still more preferably 0.020 m² or more, particularly preferably 0.040 m² or more, and most preferably 0.090 m² or more. When the area of the glass is within the above range, the glass can be suitable for use in cover glasses for various LiDARs. In addition, when the area of the glass is too large, difficulty of bending increases, such as non-uniformity of temperature distribution during heating, and deterioration of dimensional accuracy after bending. Therefore, the area of the main surface of the glass according to the present invention is preferably 1.0 m² or less, more preferably 0.90 m² or less, and still more preferably 0.80 m² or less.

The glass according to the present embodiment preferably has a thickness of 2.5 mm or more. In particular, when the glass according to the present embodiment has the above properties, the thickness of the glass is preferably 2.5 mm or more. When the thickness of the glass is 2.5 mm or more, the critical collision fracture rate of a glass having a high fracture toughness value can be improved. The thickness of the glass is more preferably 2.8 mm or more, still more preferably 2.9 mm or more, even more preferably 3.0 mm or more, even still more preferably 3.1 mm or more, yet more preferably 3.2 mm or more, yet still more preferably 3.3 mm or more, particularly preferably 3.4 mm or more, and most preferably 3.5 mm or more.

In addition, the thickness of the glass according to the present embodiment is preferably 5.0 mm or less, more preferably 4.8 mm or less, still more preferably 4.5 mm or less, particularly preferably 4.2 mm or less, and most preferably 4.0 mm or less, from the viewpoint of preventing a decrease in fuel efficiency and electric power efficiency due to an increase in the weight of the glass.

Note that examples of the method of adjusting the thickness of the glass include a method of adjusting the thickness of the glass by using a float method or a down draw method, to be described later, and a method of polishing the glass in a thickness direction by using a grindstone and then performing mirror-finishing by using an abrasive such as cerium oxide. The surface roughness Ra after forming or polishing is preferably 5.0 nm or less, more preferably 2.0 nm or less, still more preferably 1.5 nm or less, particularly preferably 1.0 nm or less, and most preferably 0.50 nm or less.

### Production Method

A method for producing the glass according to the present embodiment preferably includes a procedure of adjusting the fictive temperature. Examples of the procedure of adjusting the fictive temperature of the glass include the following procedure (A) or procedure (B).

### Procedure (A)

The procedure (A) includes the following (A-1) and (A-2).

(A-1) blending and melting predetermined glass raw materials, and then forming the molten glass into a plate glass.

(A-2) adjusting the cooling temperature profile of the glass during the forming in the (A-1).

To increase the fictive temperature of the glass in the procedure (A), it can be achieved, for example, by increasing the cooling rate near the glass transition temperature (for example, between the annealing point and the strain point), specifically, preferably to 10 °C/min or more. The cooling rate is more preferably 30 °C/min or more, still more preferably 50 °C/min or more, particularly preferably 70 °C/min or more, most preferably 100 °C/min or more. In addition, the cooling rate is preferably 800 °C/min or less, more preferably 600 °C/min or less, still more preferably 400 °C/min or less, particularly preferably 300 °C/min or less, and most preferably 200 °C/min or less, from the viewpoint of preventing a decrease in Young's modulus or fracture toughness value due to an increase in the ratio of the three-coordinated boron.

### Procedure (B)

The procedure (B) includes the following (B-1) and (B-2).

(B-1) blending and melting predetermined glass raw materials, and then forming the molten glass into a plate glass.

(B-2) heating the plate glass formed in the (B-1) to a predetermined cooling start temperature, followed by holding and then cooling the plate glass.

Examples of a known method for forming the molten glass in the (B-1) into a plate glass include a float method, a fusion method, and a roll-out method.

In the procedure (B), to lower the fictive temperature of the glass, it is sufficient to lower the cooling start temperature. The cooling start temperature is preferably Tg+20 °C or higher, more preferably Tg+30 °C or higher, still more preferably Tg+50 °C or higher, particularly preferably Tg+75 °C or higher, and most preferably Tg+100 °C or higher, from the viewpoint of preventing cracking of the glass during cooling. In addition, the cooling start temperature is preferably Tg+200 °C or lower from the viewpoint of preventing a decrease in

Young's modulus or fracture toughness value due to an increase in the ratio of the three-coordinated boron or a decrease in density. In addition, Tg+190 °C or lower is preferred, Tg+180 °C or lower is more preferred, Tg+170 °C or lower is still more preferred, Tg+160 °C or lower is particularly preferred, and Tg+150 °C or lower is most preferred.

The holding time required in the procedure (B) varies depending on the cooling start temperature, and is, for example, preferably 10 seconds or longer, more preferably 60 seconds or longer, still more preferably 120 seconds or longer, particularly preferably 180 seconds or longer, and most preferably 240 seconds or longer. In addition, it is, for example, preferably 600 seconds or shorter, and more preferably 500 seconds or shorter.

The fictive temperature of the glass can be adjusted by adjusting the cooling rate in the procedure (B). The cooling rate is preferably 1.0 °C/sec or more, more preferably 5.0 °C/sec or more, still more preferably 20 °C/sec or more, particularly preferably 40 °C/sec or more, and most preferably 60 °C/sec or more, in order to control the fictive temperature. In addition, the cooling rate is preferably 200 °C/sec or less, more preferably 180 °C/sec or less, still more preferably 160 °C/sec or less, particularly preferably 150 °C/sec or less, and most preferably 140 °C/sec or less, in order to make the temperature distribution of the glass during cooling uniform.

Specific examples of the method of performing the (B-2) include a method of performing air-cooling tempering and a method of performing bending.

In the case of performing the (B-2) by air-cooling tempering, the cooling start temperature is preferably Tg+50 °C or higher, more preferably Tg+100 °C or higher, and still more preferably Tg+120 °C or higher, from the viewpoint of increasing the compressive stress. In addition, the cooling start temperature is preferably Tg+250 °C or lower from the viewpoint of preventing the glass from softening during the air-cooling tempering. In addition, the cooling start temperature is preferably Tg+200 °C or lower, more preferably Tg+180 °C or lower, still more preferably Tg+170 °C or lower, and particularly preferably Tg+160 °C or lower.

In the case of performing the (B-2) by air-cooling tempering, the holding time is preferably 10/(cooling start temperature−Tg) seconds or longer, more preferably 30/(cooling start temperature−Tg) seconds or longer, and particularly preferably 60/(cooling start temperature−Tg) seconds or longer. In addition, for example, the holding time is preferably 600/(cooling start temperature−Tg) seconds or shorter, more preferably 300/(cooling start temperature−Tg) seconds or shorter, and particularly preferably 180/(cooling start temperature−Tg) seconds or shorter.

In the case of performing the (B-2) by air-cooling tempering, the cooling rate is preferably 10 °C/sec or more, more preferably 20 °C/sec or more, still more preferably 30 °C/sec or more, particularly preferably 50 °C/sec or more, and most preferably 60 °C/sec or more, from the viewpoint of preventing stress relaxation during cooling. In addition, the cooling rate is preferably 200 °C/sec or less, more preferably 180 °C/sec or less, still more preferably 160 °C/sec or less, particularly preferably 150 °C/sec or less, and most preferably 140 °C/sec or less, from the viewpoint of preventing cracking during cooling.

In the case of performing the (B-2) by bending, the cooling start temperature is preferably Tg+40 °C or higher, more preferably Tg+60 °C or higher, still more preferably Tg+80 °C or higher, and particularly preferably Tg+100 °C or higher, from the viewpoint of improving bendability. In addition, the cooling start temperature is preferably Tg+250 °C or lower from the viewpoint of maintaining the shape of the glass after forming. In addition, the cooling start temperature is preferably Tg+230 °C or lower, more preferably Tg+200 °C or lower, still more preferably Tg+180 °C or lower, and particularly preferably Tg+160 °C or lower.

In the case of performing the (B-2) by bending, the holding time is preferably 10/(cooling start temperature−Tg) seconds or longer, more preferably 30/(cooling start temperature−Tg) seconds or longer, still more preferably 60/(cooling start temperature−Tg) seconds or longer, particularly preferably 120/(cooling start temperature−Tg) seconds or longer, and most preferably 180/(cooling start temperature−Tg) seconds or longer. In addition, for example, the holding time is preferably 600/(cooling start temperature−Tg) seconds or shorter, more preferably 540/(cooling start temperature−Tg) seconds or shorter, still more preferably 480/(cooling start temperature−Tg) seconds or shorter, particularly preferably 420/(cooling start temperature−Tg) seconds or shorter, and most preferably 360/(cooling start temperature−Tg) seconds or shorter.

In the case of performing the (B-2) by bending, the cooling rate is preferably 1.0 °C/sec or more, more preferably 10 °C/sec or more, still more preferably 20 °C/sec or more, particularly preferably 30 °C/sec or more, and most preferably 60 °C/sec or more, from the viewpoint of preventing a shape change after bending. In addition, the cooling rate is preferably 200 °C/sec or less, more preferably 180 °C/sec or less, still more preferably 160 °C/sec or less, particularly preferably 150 °C/sec or less, and most preferably 140 °C/sec or less, from the viewpoint of preventing cracking during cooling.

### (Air-Cooling Tempering)

The glass according to the present embodiment may be a glass that has been subjected to air-cooling tempering (air-cooled tempered glass). The strength of the glass can be increased by performing an air-cooling tempering treatment. The air-cooling tempering is a treatment of forming a compressive stress layer on the glass surface by a thermal strengthening treatment. Specifically, a uniformly heated glass is rapidly cooled from a temperature near the softening point to generate compressive stress on the glass surface due to a temperature difference between the surface and the inside of the glass. The compressive stress is generated uniformly over the entire surface of the glass, and a compressive stress layer having a uniform depth is formed over the entire surface of the glass. The thermal strengthening treatment is more suitable for strengthening a thick glass than a chemical strengthening treatment.

Each of the magnitude of the compressive stress on the glass surface (hereinafter, also referred to as a surface compressive stress CS) and the depth DOL of the compressive stress layer formed on the glass surface can be adjusted based on the glass composition, the heat treatment temperature, and the cooling rate after the heat treatment.

In the case where the glass according to the present embodiment is a glass that has been subjected to air-cooling tempering, the surface compressive stress CS is preferably 30 MPa or more, more preferably 50 MPa or more, still more preferably 60 MPa or more, particularly preferably 70 MPa or more, and most preferably 80 MPa or more, from the viewpoint of improving durability and strength. In addition, the upper limit of the surface compressive stress (CS) is not particularly limited. However, a higher CS is balanced with a higher internal tensile stress, and as CS increases, energy accumulation due to a tensile stress occurs inside. Accordingly, the energy released during crushing is large, which is dangerous. Therefore, the surface compressive stress CS is preferably 500 MPa or less, more preferably 300 MPa or less, still more preferably 200 MPa or less, particularly preferably 175 MPa or less, and most preferably 150 MPa or less.

In the case where the glass according to the present embodiment is a glass that has been subjected to air-cooling tempering, the compressive stress layer depth DOL is preferably 0.15t mm or more, more preferably 0.16t mm or more, still more preferably 0.17t mm or more, particularly preferably 0.18t mm or more, and most preferably 0.19t mm or more where t represent the thickness (unit: mm) of the glass, from the viewpoint of improving durability and strength. In addition, the upper limit thereof is not particularly limited, but when the DOL is too large, the thickness of the tensile stress layer is small, which makes it difficult to balance with the compressive stress layer. Therefore, the DOL is preferably 0.35t mm or less, more preferably 0.33t mm or less, still more preferably 0.30t mm or less, particularly preferably 0.27t mm or less, and most preferably 0.25t mm or less.

### (Bending)

The glass according to the present embodiment may be a glass that has been subjected to bending (bent glass). Examples of the bent glass include a bent glass obtained by forming a flat plate-shaped glass into a curved shape by gravity forming, press forming, or the like.

The bent glass according to the present embodiment is a glass that curves with a predetermined curvature, and may be a single bent glass that curves only in either the vertical direction or the horizontal direction, or may be a multi-bent glass that curves both in the vertical direction and the horizontal direction.

The bent glass according to the present embodiment preferably has a minimum radius of curvature of 50 mm or more and 100,000 mm or less. Regarding the radius of curvature of the bent glass, the shape of a sample is calculated by a shape simulation using a laser displacement meter (Dyvoce manufactured by Kohzu Precision Co., Ltd.) based on the amount of warpage inherent in the sample, which is determined by self-weight deflection correction in a double-sided difference mode, and the radius of curvature is determined based on the shape obtained by the simulation.

### [Method for Producing Bent Glass]

In a method for producing the bent glass according to the present embodiment, a bent glass can be formed by heating and bending a plate glass. Specific examples include a method of heating a flat plate-shaped glass, and, in a state of being placed in a mold, pressing the heated glass from above by using a press, to bend the glass.

Other examples include a method of placing a flat plate-shaped glass on a mold having a bending surface corresponding to a desired curved surface, carrying the mold into a heating furnace in this state, and heating the glass in the heating furnace to a temperature near the softening point of the glass. According to this forming method, since the glass curves along the bending surface of the mold due to its own weight along with softening, a bent glass having a desired curved surface is produced.

In the present embodiment, from the viewpoint of improving productivity and improving surface accuracy after forming, the above bending using a press is preferred. The above bending method using a press is not particularly limited, and for example, the method described in WO 2016/093031 can be used as appropriate. Hereinafter, the above bending method using a press is described by way of example.

First, the glass according to the present embodiment is transported to a press area by using a transport conveyor or the like. Next, in the press area, the glass is softened by heating it to a temperature at which bending can be performed.

Here, the temperature at which bending can be performed is, for example, equal to or higher than the temperature T₁₂ at which the glass viscosity reaches 1012 [dPa·s]. Note that the heating may be performed by using a heater or the like in the heating furnace in the process of transporting the glass to the press area by using the transport conveyor or the like.

In addition, the bending time under the condition that the heating temperature (≥T₁₂) is maintained can be set to, for example, 1 second or longer.

A lower press mold (female mold) and an upper press mold (male mold) are disposed at predetermined positions in the press area, and the upper surface shape of the female mold and the lower surface shape of the male mold correspond to the curved shape of the glass to be subjected to the bending in a transporting direction and an orthogonal direction. The female mold can be moved up and down between a standby position below the transport conveyor and a press position above the transport conveyor, and after the glass is transferred from the transport conveyor, the female mold is moved up from a predetermined raised position to the press position above the transport conveyor with the glass placed thereon, whereby the glass is subjected to press forming. Next, the press-formed glass is transported to a cooling area by using a transport shuttle or the like. In the cooling area, the glass is cooled by, for example, blowing cooling air to the glass.

With the above steps, a bent glass is formed. Note that although the glass bending according to the present embodiment has been described above, the bending may also be performed in the state of a laminated glass to be described later.

### [Laminated Glass]

A laminated glass according to the present embodiment includes a first glass plate, a second glass plate, and an interlayer sandwiched between the first glass plate and the second glass plate, in which the first glass plate and/or the second glass plate is the glass according to the present embodiment.

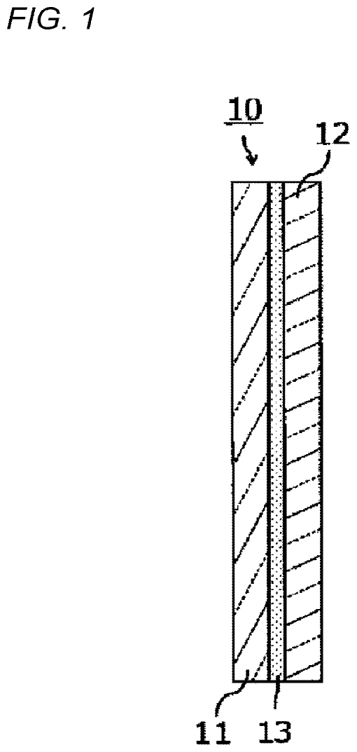

FIG. 1 is a view illustrating an example of a laminated glass 10 according to the present embodiment. The laminated glass 10 includes a first glass plate 11, a second glass plate 12, and an interlayer 13 sandwiched between the first glass plate 11 and the second glass plate

12. Note that the laminated glass 10 according to the present embodiment is not limited to the aspect in FIG. 1, and can be modified without departing from the gist of the present invention.

For example, the interlayer 13 may be formed as one layer as illustrated in FIG. 1, or may be formed as two or more layers. In addition, the laminated glass 10 according to the present embodiment may include three or more glass plates, and in this case, an organic resin or the like may be interposed between adjacent glass plates. Hereinafter, the laminated glass 10 according to the present embodiment is described as a configuration in which only two glass plates, that is, the first glass plate 11 and the second glass plate 12, are included, and the interlayer 13 is sandwiched therebetween.

In the laminated glass according to the present embodiment, the first glass plate 11 and/or the second glass plate 12 is preferably the glass according to the present embodiment from the viewpoint of bendability. In the case where the first glass plate 11 and the second glass plate 12 are each the glass according to the present embodiment, glass plates having the same composition or glass plates having different compositions may be used as the first glass plate 11 and the second glass plate 12.

In the laminated glass according to the present embodiment, in the case where the first glass plate 11 or the second glass plate 12 is not the glass according to the present embodiment, the kind of the glass plate is not particularly limited, and a known glass plate used for a vehicular window glass or the like can be used. Specific examples thereof include an alkali aluminosilicate glass, an alkali aluminoborosilicate glass, and a soda lime glass. These glass plates may be colored to such an extent that transparency thereof is not impaired, or may not be colored.

The first glass plate 11 preferably has a thickness of 3.0 mm or more. When the thickness of the first glass plate 11 is 3.0 mm or more, durability of the laminated glass can be improved. The thickness of the first glass plate 11 is more preferably 3.1 mm or more, still more preferably 3.2 mm or more, even more preferably 3.3 mm or more, even still more preferably 3.4 mm or more, yet more preferably 3.5 mm or more, yet still more preferably 3.6 mm or more, particularly preferably 3.7 mm or more, and most preferably 3.8 mm or more.

In addition, the thickness of the first glass plate 11 is preferably 10 mm or less, more preferably 9.0 mm or less, still more preferably 8.0 mm or less, even more preferably 7.0 mm or less, even still more preferably 6.0 mm or less, yet more preferably 5.5 mm or less, yet still more preferably 5.0 mm or less, particularly preferably 4.8 mm or less, and most preferably 4.5 mm or less, from the viewpoint of preventing a decrease in fuel efficiency and electric power efficiency due to an increase in the weight of the glass.

The second glass plate 12 has a thickness of preferably 1.1 mm or more, more preferably 1.2 mm or more, still more preferably 1.3 mm or more, particularly preferably 1.4 mm or more, particularly preferably 1.5 mm or more, and most preferably 1.6 mm or more. The thickness of the second glass plate 12 is preferably 1.1 mm or more from the viewpoint of impact resistance.

In addition, the thickness of the second glass plate 12 is preferably 3.0 mm or less, more preferably 2.8 mm or less, still more preferably 2.6 mm or less, particularly preferably 2.4 mm or less, particularly preferably 2.2 mm or less, and most preferably 2.0 mm or less. When the thickness of the second glass plate 12 is 3.0 mm or less, the weight of the laminated glass 10 is not too large, which is preferred from the viewpoint of improving fuel efficiency in the case of being used for a vehicle.

The first glass plate 11 and the second glass plate 12 may have the same thickness or different thicknesses, and the first glass plate 11 is preferably thicker than the second glass plate 12. That is, a relationship between the thickness t1 of the first glass plate 11 and the thickness t2 of the second glass plate 12 is preferably t1≥t2, and more preferably t1>t2.

Examples of the method of adjusting the thickness of the first glass plate 11 and the second glass plate 12 include a method of adjusting the thickness of the glass by using a float method or a down draw method, and a method of polishing the glass in a thickness direction by using a grindstone and then performing mirror-finishing using an abrasive such as cerium oxide. The surface roughness Ra after forming or polishing is preferably 5.0 nm or less, more preferably 2.0 nm or less, still more preferably 1.5 nm or less, particularly preferably 1.0 nm or less, and most preferably 0.50 nm or less.

In the laminated glass 10 according to the present embodiment, the thicknesses of the first glass plate 11 and the second glass plate 12 may be constant over the entire surface, or may be changed for each portion as necessary, such as forming a wedge shape in which the thickness of one or both of the first glass plate 11 and the second glass plate 12 gradually decreases.

The first glass plate 11 or the second glass plate 12 may be a chemically strengthened glass that has been subjected to glass strengthening in order to improve strength. The method of the chemical strengthening treatment is the same as the chemical strengthening treatment for the glass described above. Examples of the chemically strengthened glass include the above alkali aluminosilicate glass and the above alkali aluminoborosilicate glass that have been subjected to a chemical strengthening treatment.

The shape of the first glass plate 11 and the second glass plate 12 may be a flat plate shape, or may be a curved shape having a curvature on the entire surface or a part thereof. In the case where the first glass plate 11 and the second glass plate 12 are curved, the first glass plate 11 and the second glass plate 12 may have a single-curved shape curved only in either the vertical direction or the horizontal direction, or may have a multi-curved shape curved in both the vertical direction and the horizontal direction. In the case where the first glass plate 11 and the second glass plate 12 have the multi-curved shape, a radius of curvature thereof may be the same or different in the vertical direction and the horizontal direction. In the case where the first glass plate 11 and the second glass plate 12 are curved, the radius of curvature in the vertical direction and/or the horizontal direction is preferably 1000 mm or more. The shape of the main surface of the first glass plate 11 and the second glass plate 12 is a shape that fits a window opening of a vehicle on which the first glass plate 11 and the second glass plate 12 are to be mounted.

The interlayer 13 is sandwiched between the first glass plate 11 and the second glass plate 12. Since the laminated glass 10 according to the present embodiment includes the interlayer 13, the first glass plate 11 and the second glass plate 12 firmly adhere to each other, and an impact force when scattered pieces collide with the glass plates can be reduced.

As the interlayer 13, various organic resins generally used for a laminated glass used as a vehicular laminated glass in the related art can be used. Examples of the organic resin that can be used include a polyethylene (PE), an ethylene vinyl acetate copolymer (EVA), a polypropylene (PP), a polystyrene (PS), a methacrylic resin (PMA), polyvinyl chloride (PVC), a polyethylene terephthalate (PET), a polybutylene terephthalate (PBT), cellulose acetate (CA), a diallyl phthalate resin (DAP), a urea resin (UP), a melamine resin (MF), an unsaturated polyester (UP), a polyvinyl butyral (PVB), polyvinyl formal (PVF), polyvinyl alcohol (PVAL), a vinyl acetate resin (PVAc), an ionomer (IO), a polymethylpentene (TPX), a polyvinylidene chloride (PVDC), a polysulfone (PSF), a polyvinylidene difluoride (PVDF), a methacrylate-styrene copolymer resin (MS), a polyarylate (PAR), a polyarylsulfone (PASF), a polybutadiene (BR), a polyethersulfone (PESF), or a polyether ether ketone (PEEK). Among these, EVA and PVB are suitable from the viewpoint of transparency and adhesion, and particularly, PVB is more preferred since PVB can impart sound insulation property.

The interlayer 13 has a thickness of preferably 0.300 mm or more, more preferably 0.500 mm or more, and still more preferably 0.700 mm or more, from the viewpoint of relaxation in impact force and sound insulation property. In addition, the thickness of the interlayer 13 is preferably 1.00 mm or less, more preferably 0.900 mm or less, and still more preferably 0.800 mm or less, from the viewpoint of preventing a decrease in visible light transmittance. In addition, the thickness of the interlayer 13 is preferably in a range of 0.300 mm to 1.00 mm, and more preferably in a range of 0.700 mm to 0.800 mm.

The thickness of the interlayer 13 may be constant over the entire surface, or may be changed for each portion as necessary.

Note that when a difference in linear expansion coefficient between the interlayer 13 and the first glass plate 11 or the second glass plate 12 is large, in the case of preparing the laminated glass 10 through a heating step to be described later, the laminated glass 10 may be cracked or warped, resulting in a poor appearance. Therefore, the difference in linear expansion coefficient between the interlayer 13 and the first glass plate 11 or the second glass plate 12 is preferably as small as possible. The difference in linear expansion coefficient between the interlayer 13 and the first glass plate 11 or the second glass plate 12 may be represented by a difference between average linear expansion coefficients in a predetermined temperature range.

Particularly, since a resin constituting the interlayer 13 has a low glass transition temperature, a predetermined difference in average linear expansion coefficient may be set in a temperature range equal to or lower than the glass transition temperature of the resin material.

Note that the difference in linear expansion coefficient between the resin material and the first glass plate 11 or the second glass plate 12 may be set by a predetermined temperature equal to or lower than the glass transition temperature of the resin material.

As the interlayer 13, an adhesive layer containing an adhesive may be used, and the adhesive is not particularly limited, and for example, an acrylic adhesive or a silicone adhesive can be used.

In the case where the interlayer 13 is an adhesive layer, it is not necessary to perform a heating step in the process of bonding the first glass plate 11 and the second glass plate 12, and thus the above cracking or warpage is less likely to occur.

### [Other Layers]

The laminated glass 10 according to the present embodiment may include layers other than the first glass plate 11, the second glass plate 12, and the interlayer 13 (hereinafter, also referred to as “other layers”) within a range that does not impair effects of the present embodiment. For example, a coating layer that provides a water repellent function, a hydrophilic function, an anti-fogging function, or the like, or an infrared reflection film may be provided.

Positions where the other layers are provided are not particularly limited, and the other layers may be provided on a surface of the laminated glass 10, or may be sandwiched among the first glass plate 11, the second glass plate 12, and the interlayer 13. In addition, the laminated glass 10 according to the present embodiment may include a black ceramic layer or the like which is disposed in a band shape on a part or all of a peripheral edge portion for the purpose of hiding an attachment portion to a frame body or the like, a wiring conductor, or the like.

In the laminated glass according to the present embodiment, the total thickness of the first glass plate 11, the second glass plate 12, and the interlayer 13 is preferably 4.4 mm or more. When the total thickness is 4.4 mm or more, sound insulation property can be improved. The total thickness is more preferably 4.8 mm or more, still more preferably 5.0 mm or more, even more preferably 5.1 mm or more, particularly preferably 5.2 mm or more, and most preferably 5.3 mm or more.

In addition, the total thickness is preferably 14 mm or less, more preferably 12 mm or less, still more preferably 10 mm or less, particularly preferably 9.0 mm or less, particularly preferably 8.0 mm or less, and most preferably 7.0 mm or less, from the viewpoint of weight reduction. Note that in the case where the total thickness of the first glass plate 11, the second glass plate 12, and the interlayer 13 varies depending on the portion, the total thickness is preferably 4.4 mm or more at the thinnest portion.

In the laminated glass according to the present embodiment, the ratio (t1/t2) of the thickness t1 of the first glass plate to the thickness t2 of the second glass plate is preferably 1.1 or more. When the ratio (t1/t2) is 1.1 or more, high durability can be achieved. The ratio (t1/t2) is more preferably 1.3 or more, still more preferably 1.5 or more, even more preferably 1.8 or more, even still more preferably 2.0 or more, yet more preferably 2.2 or more, yet still more preferably 2.3 or more, particularly preferably 2.4 or more, and most preferably 2.5 or more. In addition, in order to approximate the curvature when the glass after bending is formed into a laminated glass, the ratio (t1/t2) is preferably 5.0 or less, more preferably 4.5 or less, still more preferably 4.0 or less, even more preferably 3.8 or less, even still more preferably 3.5 or less, yet more preferably 3.3 or less, yet still more preferably 3.2 or less, particularly preferably 3.1 or less, and most preferably 3.0 or less.

In the case where the laminated glass 10 according to the present embodiment is for a vehicular glass application, the visible light transmittance Tv defined in ISO-9050:2003 using a D65 light source is preferably 70% or more. The Tv is more preferably 71% or more, and still more preferably 72% or more. In addition, the Tv is, for example, 90% or less.

In the case where the laminated glass 10 according to the present embodiment is for a vehicular glass application, the total solar transmittance Tts is preferably 70% or less, as defined in ISO-13837:2008 convention A and measured at a wind speed of 4 m/s. When the total solar transmittance Tts of the laminated glass 10 according to the present embodiment is 70% or less, a sufficient heat shielding property can be obtained. The Tts is more preferably 68% or less, and still more preferably 66% or less. In addition, the Tts is, for example, 55% or more.

A method for producing the laminated glass 10 according to the present embodiment may be the same as that for a known laminated glass in the related art. For example, through steps of laminating the first glass plate 11, the interlayer 13, and the second glass plate 12 in this order and performing heating and pressing, the laminated glass 10 having a configuration in which the first glass plate 11 and the second glass plate 12 are bonded to each other via the interlayer 13 can be obtained.

In the method for producing the laminated glass 10 according to the present embodiment, for example, after a step of heating and forming each of the first glass plate 11 and the second glass plate 12, a step of inserting the interlayer 13 between the first glass plate 11 and the second glass plate 12 and performing heating and pressing may be performed. Through such steps, the laminated glass 10 having a configuration in which the first glass plate 11 and the second glass plate 12 are bonded to each other via the interlayer 13 may be obtained.

### Application

The glass according to the present embodiment is for buildings, vehicles, or sensors, and more specifically, can be preferably used as a window glass or a cover glass of a sensor in a building or a vehicle.

In particular, since the glass according to the present embodiment has excellent durability and formability, the glass is suitable for use as a window glass in a building or a vehicle, specifically, a member such as a windshield, a side glass, a rear glass, or a roof glass. In addition, from the same viewpoint, the glass can be suitably used particularly as a cover glass for a vehicle or a sensor such as a LiDAR, a camera, or a millimeter wave radar to be mounted on an unmanned or manned eVTOL (electric vertical take-off and landing aircraft) such as a drone.

Hereinafter, as a specific application, an example in which the glass according to the present embodiment is used as a vehicular window glass is described with reference to the drawings.

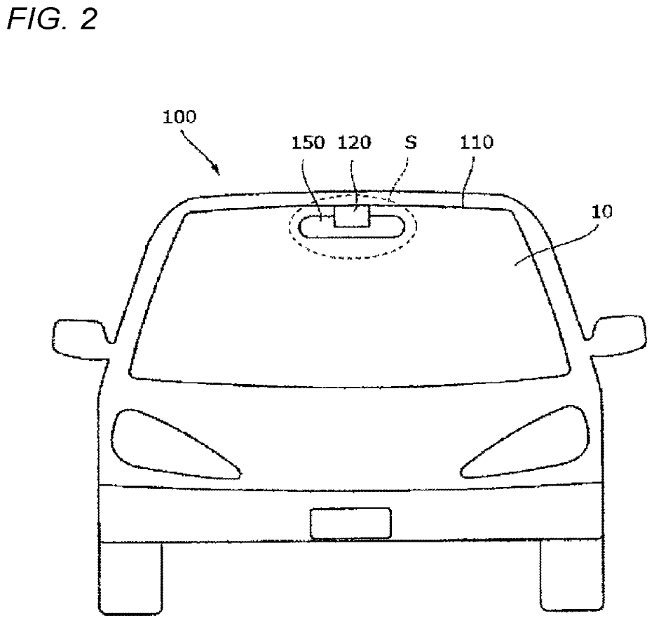

FIG. 2 is a conceptual view illustrating a state where the laminated glass 10 including the glass according to the present embodiment is mounted on an opening 110 formed at a front part of an automobile 100 and used as an automobile window glass.

In the laminated glass 10 used as the automobile window glass, a housing (case) 120 in which an information device or the like is housed for ensuring traveling safety of the vehicle may be attached to a surface on the vehicle inner side.

The information device housed in the housing is a device that uses a camera, a radar, or the like to prevent rear-end collision or collision with a preceding vehicle, a pedestrian, an obstacle, or the like in front of the vehicle or to notify a driver of a danger. For example, the information device is an information receiving device and/or an information transmitting device, includes a millimeter wave radar, a stereo camera, an infrared laser, or the like, and transmits and/or receives a signal. The “signal” is an electromagnetic wave including a millimeter wave, visible light, infrared light, or the like.

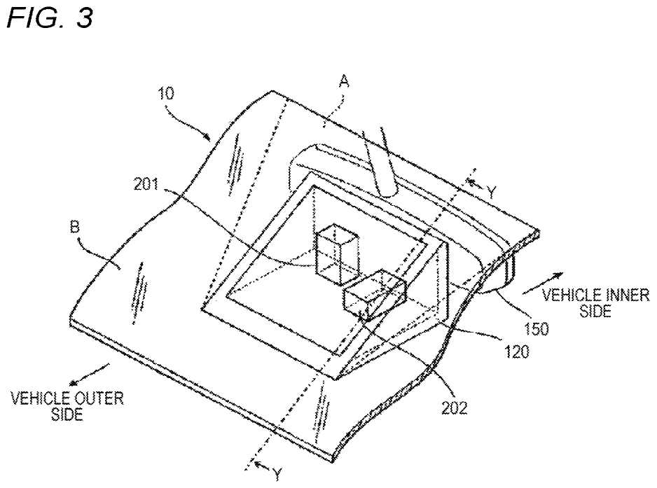

FIG. 3 is an enlarged view of portion S in FIG. 2, and is a perspective view illustrating a portion where the housing 120 is attached to the laminated glass 10 according to the present embodiment. The housing 120 houses a millimeter wave radar 201 and a stereo camera 202 as the information device. The housing 120 in which the information device is housed is generally attached to the vehicle outer side with respect to a back mirror 150 and the vehicle inner side with respect to the laminated glass 10, or may be attached to another portion.

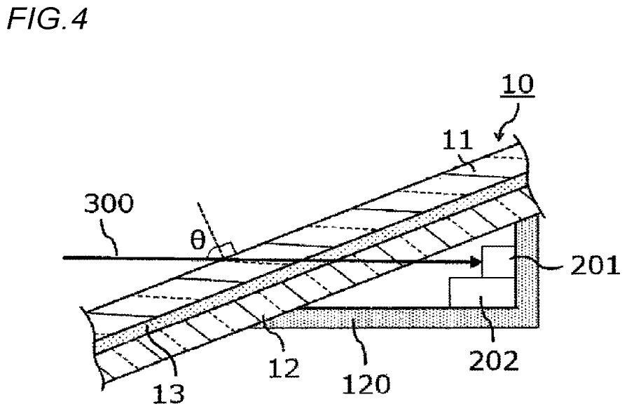

FIG. 4 is a cross-sectional view including line Y-Y in FIG. 3 in a direction orthogonal to the horizontal line. The first glass plate 11 in the laminated glass 10 is preferably disposed on the vehicle outer side. With the above configuration, a windshield that is lightweight and has excellent durability can be implemented. In addition, since the glass according to the present embodiment has a low Young's modulus, it is easy to perform the bending when producing a windshield.

As described above, the following configurations are disclosed in the present description.

1. A glass for a building, for a vehicle, or for a sensor, containing, in terms of mol % based on oxides:
SiO₂: 65% to 80%;
B₂O₃: 8.0% to 20%;
Al₂O₃: 1.0% to 6.0%;
MgO: 0.0% to 5.0%;
CaO: 0.0% to 5.0%;
SrO: 0.0% to 5.0%;
BaO: 0.0% to 5.0%;
Li₂O: 0.0% to 10%;
Na₂O: 5.0% to 20%;
K₂O: 0.0% to 10%;
total iron oxide in terms of Fe₂O₃: 0.004% to 1.0%;
R′₂O: 5.0% to 20%; and
RO: 0.0% to 5.0% (where RO represents a total content of MgO, CaO, SrO, and BaO, and R′₂O represents a total content of Li₂O, Na₂O, and K₂O), and
having a fictive temperature Tf being a glass transition temperature+10 °C or higher and being 500 °C or higher and 750 °C or lower.

2. The glass according to the above 1, in which the fictive temperature Tf is lower than 650 °C.

3. The glass according to the above 1, in which the fictive temperature Tf is 650 °C or higher.

4. The glass according to any one of the above 1 to 3, which is a bent glass.

5. The glass according to any one of the above 1 to 3, which is an air-cooled tempered glass.

6. The glass according to the above 5, having a compressive stress (CS) of 30 MPa or more and a compressive stress layer depth (DOL) of 0.2×t (mm) or more, t representing a thickness (mm) of the air-cooled tempered glass.

7. A laminated glass including:
a first glass plate;
a second glass plate; and
an interlayer sandwiched between the first glass plate and the second glass plate, in which
the first glass plate, the second glass plate, or both is the glass according to any one of the above 1 to 6.

8. The laminated glass according to the above 7, in which a relationship between a thickness t1 of the first glass plate and a thickness t2 of the second glass plate is t1≥ t2.

9. The laminated glass according to the above 7 or 8, in which the thickness t1 of the first glass plate is 3.0 mm or more, the thickness t2 of the second glass plate is 1.1 mm or more, and a total t1+t2 of t1 and t2 is 10 mm or less.

### EXAMPLES

Hereinafter, the present invention is specifically described with reference to Examples, but the present invention is not limited thereto.

### <Preparation of Glass Plate>

Raw materials were charged into a platinum crucible so as to obtain each glass composition (unit: mol %) shown in Table 1, and melted at a temperature of 1,600 °C to 1,650 °C for 3 hours to obtain each molten glass. “Fe₂O₃” in Table 1 represents the total iron oxide in terms of Fe₂O₃. The molten glass was poured onto a carbon plate, held at a temperature equal to or higher than the glass transition temperature and equal to or lower than the Tu for 3 hours, and then annealed at a condition of an average cooling rate of 1 °C/min. Both surfaces of the obtained plate-shaped glass were polished to obtain a glass plate having a thickness of 3.1 mm. Examples 1 to 11 are Inventive Examples, and Examples 12 to 15 are Comparative Examples.

### <Air-Cooling Tempering Treatment>

A glass having a thickness of 3.1 mm and a size of 45 mm square was heated in an electric furnace at 650 °C (Examples 3, 6, 10, and 14) or 700 °C (Examples 4, 7, 11, and 15), and immediately after the surface of the glass reached a target temperature, the glass was taken out from the electric furnace and cooled at a wind pressure of 3.4 kPa for 60 seconds to perform an air-cooling tempering treatment. The heating time was 180 seconds.

The results of evaluating the glass plates obtained above as follows are shown in Table 1. Note that blank columns in the table indicate not measured. In Table 1, a numerical value with “*” indicates a value before the air-cooling tempering treatment. In addition, in an example in which the air-cooling tempering treatment is performed, the results when the air-cooling tempering treatment was performed on a glass plate having a thickness of 3.1 mm are shown.

### (1) Glass Transition Temperature (Tg):

The glass transition temperature was a value measured using TMA and determined according to the standard in JIS R3103-3 (2001).

### (2) Fictive Temperature (Tf):

The fictive temperature Tf was determined by the following procedures 1) to 3).

1) First, i (i≥2) test pieces were prepared from a glass sample whose fictive temperature was to be measured. Each test piece was charged into an electric furnace and held at different cooling start temperatures (550 °C, 575 °C, 600 °C, 625 °C, 650 °C, 675 °C, or 700 °C) until the refractive index reached an equilibrium state. Thereafter, each test piece was taken out from the electric furnace to the outside of the furnace at room temperature of 25 °C, and cooled at a cooling rate of 1,000 °C/min or more from the cooling start temperature. 2) The refractive index n_{d} of the glass cooled under the conditions described in the 1) was measured at a specific wavelength (for example, the d-line of a He lamp, 587.6 nm). For each cooling start temperature Tᵢ, the refractive index n_{di} of the glass rapidly cooled from the cooling start temperature was plotted to create a calibration curve. 3) Next, a test piece was cut out from the glass sample whose fictive temperature Tf was to be measured, and was polished, the refractive index n_{d} of the polished test piece was measured, and the fictive temperature Tf of the glass was determined using the calibration curve.

### (3) Temperature T₁₁:

The temperature Tu at which the viscosity η as a standard of bendability of the glass reached 1011 dPa·s was measured by using a beam bending method.

### (4) Average Linear Expansion Coefficient at 50 °C to 350 °C (CTE₅₀₋₃₅₀):

The average thermal expansion coefficient was measured by using a differential thermal dilatometer (TMA) and was determined based on the standard in JIS R3102 (1995).

### (5) Density:

The density of about 20 g of a glass mass containing no bubble and cut out from the glass plate was measured by using the Archimedes method.

### (6) Young's Modulus:

The Young's modulus was measured at 25 °C by using an ultrasonic pulse method (Olympus, DL35) based on JIS R1602:1995 “Testing methods for elastic modulus of fine ceramics”.

### (7) Rigidity Modulus:

The rigidity modulus was measured at 25 °C by using an ultrasonic pulse method (Olympus, DL35) based on JIS R1602:1995 “Testing methods for elastic modulus of fine ceramics”.

### (8) Poisson's Ratio:

The Poisson's ratio was measured at 25 °C by using an ultrasonic pulse method (Olympus, DL35) based on JIS R1602:1995 “Testing methods for elastic modulus of fine ceramics”.

### (9) Compressive Stress CS and Compressive Stress Layer Depth DOL

The compressive stress CS and the compressive stress layer depth DOL were measured by using a scattered light photoelastic stress meter SLP-2000 and a glass surface stress meter FSM, manufactured by Orihara Industrial Co., Ltd.

TABLE 1

| mol % | Ex. 1 | Ex. 2 | Ex. 3 | Ex. 4 | Ex. 5 | Ex. 6 | Ex. 7 |
|---|---|---|---|---|---|---|---|
| SiO₂ | 75.2 | 75.2 | 75.2 | 75.2 | 75.5 | 75.5 | 75.5 |
| B₂O₃ | 12.1 | 12.1 | 12.1 | 12.1 | 13.7 | 13.7 | 13.7 |
| Al₂O₃ | 2.8 | 2.8 | 2.8 | 2.8 | 1.8 | 1.8 | 1.8 |
| MgO | 0.0 | 0.0 | 0.0 | 0.0 | 0.0 | 0.0 | 0.0 |
| CaO | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| Li₂O | 2.5 | 2.5 | 2.5 | 2.5 | 0.0 | 0.0 | 0.0 |
| Na₂O | 6.9 | 6.9 | 6.9 | 6.9 | 7.8 | 7.8 | 7.8 |
| KO | 0.3 | 0.3 | 0.3 | 0.3 | 1.2 | 1.2 | 1.2 |
| Fe₂O₃ | 0.20 | 0.20 | 0.20 | 0.20 | 0.0080 | 0.0080 | 0.0080 |
| R′₂O | 9.7 | 9.7 | 9.7 | 9.7 | 9.0 | 9.0 | 9.0 |
| RO | 0.0 | 0.0 | 0.0 | 0.0 | 0.0 | 0.0 | 0.0 |
| Tg [°C] | 520 | 520 | 520* | 520* | 558 | 558* | 558* |
| Tf [°C] | 550 | 620 | 650 | 700 | 580 | 650 | 700 |
| T₁₁ [°C] | 597 | 597* | 597* | 597* | 632 | 632* | 632* |
| CTE₅₀₋₃₅₀ [×10⁻⁷/°C] | 55 | 55* | 55* | 55* | 57 | 57* | 57* |
| Density [g/cm³] | 2.33 | 2.32 | 2.31 | 2.31 | 2.34 | 2.33 | 2.33 |
| Young's modulus [GPa] | 74 | 72 | 71 | 71 | 73 | 69 | 69 |
| Rigidity modulus [GPa] | 31 | 31 | 30 | 30 | 30 | 29 | 29 |
| Poisson's ratio [—] | 0.19 | 0.19 | 0.19 | 0.19 | 0.19 | 0.19 | 0.19 |
| Air-cooling tempering | No | No | Treatment | Treatment | No | Treatment | Treatment |
| treatment | treatment | treatment | | | treatment | | |
| CS [MPa] | 30 or less | 30 or less | 68 | 69 | 30 or less | | |
| DOL [μm] | Less than | Less than | 0.15 t or | 0.15 t or | Less than | 0.15 t or | 0.15 t or |
| | 0.15 t | 0.15 t | more | more | 0.15 t | more | more |

| mol % | Ex. 8 | Ex. 9 | Ex. 10 | Ex. 11 | Ex. 12 | Ex. 13 | Ex. 14 | Ex. 15 |
|---|---|---|---|---|---|---|---|---|
| SiO₂ | 76.0 | 76.0 | 76.0 | 76.0 | 69.5 | 83.5 | 83.5 | 83.5 |
| B₂O₃ | 12.7 | 12.7 | 12.7 | 12.7 | 0.0 | 11.6 | 11.6 | 11.6 |
| Al₂O₃ | 3.4 | 3.4 | 3.4 | 3.4 | 0.9 | 1.2 | 1.2 | 1.2 |
| MgO | 2.0 | 2.0 | 2.0 | 2.0 | 7.1 | 0.0 | 0.0 | 0.0 |
| CaO | 0.0 | 0.0 | 0.0 | 0.0 | 9.1 | 0.0 | 0.0 | 0.0 |
| SrO | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 | 0.0 |
| Na₂O | 5.0 | 5.0 | 5.0 | 5.0 | 12.6 | 3.3 | 3.3 | 3.3 |
| K₂O | 0.9 | 0.9 | 0.9 | 0.9 | 0.60 | 0.5 | 0.5 | 0.5 |
| Fe₂O₃ | 0.040 | 0.040 | 0.040 | 0.040 | 0.19 | 0.0070 | 0.0070 | 0.0070 |
| R′₂O | 5.5 | 5.9 | 5.9 | 5.9 | 13.2 | 3.8 | 3.8 | 3.8 |
| RO | 2.0 | 2.0 | 2.0 | 2.0 | 16.2 | 0.0 | 0.0 | 0.0 |
| Tg [°C] | 560 | 560* | 560* | 560* | 550 | 525 | 525* | 525* |
| Tf [°C] | 590 | 650 | 650 | 700 | 580 | 555 | 650 | 700 |
| T₁₁ [°C] | 639 | 639* | 639* | 639* | 613 | 650 | 650* | 650* |
| CTE₅₀₋₃₅₀ [×10⁻⁷/°C] | 47 | 47* | 47* | 47* | 91 | 33 | 33* | 33* |
| Density [g/cm³] | 2.27 | 2.25 | 2.25 | 2.25 | 2.51 | 2.22 | | |
| Young's modulus | 64 | 60 | 60 | 60 | 75 | 63 | 61 | 61 |
| [GPa] | | | | | | | | |
| Rigidity modulus | 27 | 25 | 25 | 25 | 31 | 26 | 26 | 26 |
| [GPa] | | | | | | | | |
| Poisson's ratio [—] | 0.20 | 0.20 | 0.20 | 0.20 | 0.23 | 0.19 | 0.19 | 0.19 |
| Air-cooling tempering | No | No | Treatment | Treatment | No | No | Treatment | Treatment |
| treatment | treatment | treatment | | | treatment | treatment | | |
| CS [MPa] | 30 or less | 30 or less | | | 30 or less | 10 or less | 15 | 22 |
| DOL [μm] | Less than | Less than | 0.15 t or | 0.15 t or | Less than | Less than | 0.15 t or | 0.15 t or |
| | 0.15 t | 0.15 t | more | more | 0.15 t | 0.15 t | more | more |

The Young's modulus and the CTE₅₀₋₃₅₀ of the glasses in Examples 1 to 7 as Inventive Examples were smaller than those of Example 12 as Comparative Example. In Example 12 as Comparative Example, the RO was more than 5.0% and the CTE₅₀₋₃₅₀ was large.

The CTE₅₀₋₃₅₀ in the glasses in Examples 8 to 11 as Inventive Examples was smaller than that of Examples 13 to 15 as Comparative Examples. In Examples 13 to 15 as Comparative Examples, the R′₂O was less than 5.0% and the CTE₅₀₋₃₅₀ was large.

### <Preparation of Laminated Glass>

Laminated glasses in Test Examples 1 to 5 were produced by the following procedure. Test Examples 1 to 5 are Inventive Examples.

### Test Example 1

As the first glass plate, a glass having a thickness of 3.0 mm and having a composition shown in Example 4 in Table 1 was used. As the interlayer, a polyvinyl butyral (PVB) having a thickness of 0.78 mm was used. As the second glass plate, a glass having a thickness of 1.1 mm and having a composition shown in Example 1 in Table I was used. The first glass plate, the interlayer, and the second glass plate were laminated in this order, pre-bonded at 120 °C for 15 minutes, and then pressure-bonded under conditions of 130 °C and 1 MPa. Thereafter, the temperature was returned to room temperature, and the pressure was returned to atmospheric pressure over 90 minutes to prepare a laminated glass in Test Example 1. In the laminated glass in Test Example 1, the total thickness of the first glass plate, the second glass plate, and the interlayer was 4.9 mm, and the ratio (t1/t2) of the thickness t1 of the first glass plate to the thickness t2 of the second glass plate was 2.7.

### Test Examples 2 to 5

Each laminated glass was prepared in the same manner as in Test Example 1 except that the kinds of the first glass plate and the second glass plate were changed to those shown in Table 2.

TABLE 2

| | | | Test | Test | Test | Test | Test |
|---|---|---|---|---|---|---|---|
| | | | Ex. 1 | Ex. 2 | Ex. 3 | Ex. 4 | Ex. 5 |
| Configuration | First glass plate | Glass kind | Ex. 4 | Ex. 2 | Ex. 11 | Ex. 7 | Ex. 7 |
| | | Thickness [mm] | 3.0 | 3.5 | 3.5 | 3.5 | 4.0 |
| | Interlayer | Interlayer kind | PVB | PVB | PVB | PVB | PVB |
| | | Thickness [mm] | 0.78 | 0.78 | 0.78 | 0.78 | 0.78 |
| | Second glass plate | Glass kind | Ex. 1 | Ex. 2 | Ex. 12 | Ex. 5 | Ex. 5 |
| | | Thickness [mm] | 1.1 | 1.1 | 1.5 | 1.5 | 2.0 |

| | | | | | |
|---|---|---|---|---|---|
| Total thickness [mm] of laminated glass | 4.9 | 5.4 | 5.8 | 5.8 | 6.8 |
| Ratio (t1/t2) of thickness t1of first glass | 2.7 | 3.2 | 2.3 | 2.3 | 2.0 |
| plate to thickness t2 of second glass plate | | | | | |

Although the present invention has been described in detail with reference to specific aspects, it is apparent to those skilled in the art that various changes and modifications can be made without departing from the spirit and scope of the present invention. Note that the present application is based on a Japanese patent application (Japanese Patent Application No. 2023-221646) filed on Dec. 27, 2023, the entire contents of which are incorporated herein by reference. In addition, all references cited here are entirely incorporated.

### REFERENCE SIGNS LIST

10 laminated glass
11 first glass plate
12 second glass plate
13 interlayer
100 automobile
110 opening
120 housing
150 back mirror
201 millimeter wave radar
202 stereo camera
300 radio wave

What is claimed is:

1. A glass for a building, for a vehicle, or for a sensor,
comprising, in terms of mol % based on oxides:
SiO₂: 65% to 80%;
B₂O₃: 8.0% to 20%;
Al₂O₃: 1.0% to 6.0%;
MgO: 0.0% to 5.0%;
CaO: 0.0% to 5.0%;
SrO: 0.0% to 5.0%;
BaO: 0.0% to 5.0%;
Li₂O: 0.0% to 10%;
Na₂O: 5.0% to 20%;
K₂O: 0.0% to 10%;
total iron oxide in terms of Fe₂O₃: 0.004% to 1.0%;
R′₂O: 5.0% to 20%; and
RO: 0.0% to 5.0% where RO represents a total content of MgO, CaO, SrO, and BaO, and R′₂O represents a total content of Li₂O, Na₂O, and K₂O, and
having a fictive temperature Tf being a glass transition temperature+10 °C or higher and being 500 °C or higher and 750 °C or lower.

2. The glass according to claim 1, wherein the fictive temperature Tf is lower than 650 °C.

3. The glass according to claim 1, wherein the fictive temperature Tf is 650 °C or higher.

4. The glass according to claim 1, which is a bent glass.

5. The glass according to claim 1, which is an air-cooled tempered glass.

6. The glass according to claim 5, having a compressive stress (CS) of 30 MPa or more and a compressive stress layer depth (DOL) of 0.2×t (mm) or more, t representing a thickness (mm) of the air-cooled tempered glass.

7. A laminated glass comprising:
a first glass plate;
a second glass plate; and
an interlayer sandwiched between the first glass plate and the second glass plate, wherein
the first glass plate, the second glass plate, or both is the glass according to claim 1.

8. The laminated glass according to claim 7, wherein a relationship between a thickness t1 of the first glass plate and a thickness t2 of the second glass plate is t1≥ t2.

9. The laminated glass according to claim 7, wherein the thickness t1 of the first glass plate is 3.0 mm or more, the thickness t2 of the second glass plate is 1.1 mm or more, and a total t1+t2 of t1 and t2 is 10 mm or less.

10. The glass according to claim 1, having a content of three-coordinated boron in terms of B₂O₃ of 10% or less.

11. The glass according to claim 1, having Fe-Redox of 15% or more and 50% or less, where Fe-Redox represents a mass proportion of divalent iron in terms of Fe₂O₃ in the total iron oxide in terms of Fe₂O₃.

12. The glass according to claim 1, having an average linear expansion coefficient at 50 °C to 350 °C of 40×10⁻⁷/°C or more and 70×10⁻⁷/° °C or less.

13. The glass according to claim 1, having a density of 2.50 g/cm³ or less.

14. The glass according to claim 1, having a Young's modulus of 55 GPa or more and 80 GPa or less.

15. The glass according to claim 1, having a temperature Ti of 580 °C or higher and 650 °C or lower, T₁₁ being the temperature at which a viscosity η reaches 1011 dPa·s.
